(19) United States
(12) Patent Application Publication
(10) Pub. No.: US 2012/0250036 A1
(43) Pub. Date: Oct. 4, 2012

(54) LAYOUT TEMPLATE, LAYOUT DATA GENERATING APPARATUS, AND LAYOUT DATA GENERATING METHOD AND PROGRAM

(75) Inventors: Koji HATTA, Kyoto (JP); Toshiyuki Yamasaki, Kyoto (JP)

(73) Assignee: DAINIPPON SCREEN MFG CO., LTD.

(21) Appl. No.: 13/423,923

(22) Filed: Mar. 19, 2012

(30) Foreign Application Priority Data
Mar. 30, 2011 (JP) P2011-75665

(51) Int. Cl. G06K 15/02

(52) U.S. Cl. 358/1.2

(57) ABSTRACT

In an area data group of a layout template, information pieces regarding a working-plate area, a paper area, a prepress-working area, a folding area, and a page area are defined as variables. Furthermore, in an accessory data group, the positions of accessories to be associated with the above respective areas are each defined as the relative position of the accessory with respect to a reference point set in a reference area with which the accessory is associated. This enables a layout data generating apparatus to readily respond to a change in printing conditions, such as a change in the size of the page area or the paper area, and quickly generate layout data.

### TECHNICAL FIELD

The present invention relates to a technique for generating layout data indicating the layout of a printed media.

### BACKGROUND ART

In commercial printing or the like, layout data indicating the layout of a printed media has conventionally been used. The layout data includes layout information such as the number and size of pages to be arranged on paper and the position of each page on paper, and another layout information such as the positions and sizes of accessories to be used in a printing process or a binding process, examples of the accessories including a register mark and a color bar.

In a digital imposition processor disclosed in Japanese Patent Application Laid-Open No. 11-133583, additional printing information necessary for printing is read from the outside and added to raster data such that the additional printing information is arranged at the desired position on a working plate, by a printing information addition section.

Incidentally, if the size of paper or a working plate to be used for printing has been changed, new layout data has to be generated even if pages and accessories to be arranged on paper remain unchanged. Likewise, if the positions or arrangement of pages or the like has been changed, new layout data has to be generated because the positions or the like of accessories, which are to be arranged with reference to the pages or the like, will also be changed. Meanwhile, if an apparatus such as a printing apparatus or a binding apparatus has been changed, it is necessary to change layout information regarding accessories, in which case, also, new layout data has to be generated.

As described above, for every slight change in printing conditions, a significant amount of time and effort are required for creation of new layout data, and because of this, there is a limit to an improvement in the production efficiency of a printing operation. Furthermore, since the layout data generated due to a change in printing conditions is stored and the number of layout data pieces increases with every slight change in conditions, much effort is required for management of the layout data.

### SUMMARY OF INVENTION

The present invention is intended for a technique for generating layout data indicating the layout of a printed media, and it is a primary object of the present invention to readily respond to a change in printing conditions and quickly generate layout data.

A layout template according to the present invention 1 includes an area data group including at least one page area data piece that corresponds to a page area, and paper area data that corresponds to a paper area on which the page area is to be arranged, and at least one accessory data piece that corresponds to an accessory serving as additional print information to be used in a printing process or a binding process, wherein the at least one page area data piece includes size information regarding the page area as a variable, the paper area data includes size information regarding the paper area, the number of at least one page area to be arranged on the paper area, and a position of the at least one page area on the paper area as variables, the accessory is associated with a reference area that is either the page area or the paper area, and the at least one accessory data piece includes positional information indicating a relative position of the accessory with respect to either a reference point set in the reference area or a reference point set in an area that corresponds to other area data included in the area data group. According to the present invention, it is possible to readily respond to a change in printing conditions and quickly generate layout data.

In a preferred embodiment of the present invention, the at least one accessory data piece further includes size information regarding the accessory as a function of size information regarding the reference area.

In another preferred embodiment of the present invention, the at least one accessory data piece further includes layer information indicating an above/below relationship between a layer of the accessory and a layer of an image in the reference area.

In still another embodiment of the present invention, the at least one accessory data piece further includes double-side display information indicating. in a case where double-side printing is performed on a printing medium, whether the accessory is to be printed on a front surface of the printing medium or to be printed on a back surface of the printing medium.

In still another embodiment of the present invention, the positional information regarding the accessory, which is included in the at least one accessory data piece, includes front-surface positional information that is positional information regarding a front-surface accessory to be printed on a front surface of a printing medium, and front/back linkage information for determining a position of a back-surface accessory to be printed on a back surface of the printing medium, based on the front-surface positional information.

In still another embodiment of the present invention, the area data group further includes working-plate area data that corresponds to a working-plate area, the working-plate area data including size information regarding the working-plate area and a position of the at least one paper area on the working-plate area as variables.

In still another embodiment of the present invention, the accessory is a flashing ejection pattern to be associated with the paper area.

The present invention is also intended for a layout data generating apparatus for generating layout data indicating a layout of a printed media. The layout data generating apparatus includes a storage part that stores the above-described layout template, an input receiving part that accepts input information including size information regarding the page area, size information regarding the paper area, the number of at least one page area to be arranged on the paper area, and a position of the at least one page area on the paper area, and a layout-data generating part that generates layout data by substituting the input information into the layout template.

The present invention is also intended for a layout data generating method and a storage medium that stores a program for generating layout data.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 shows a configuration of a layout data generating apparatus according to an embodiment of the present invention;

FIG. 2 is a block diagram showing a functional configuration of the layout data generating apparatus;

FIG. 3 shows the data structure of a layout template;

FIG. 4 shows a layout model corresponding to the layout template;

FIG. 5 shows reference points in a working-plate area;

FIG. 6 shows the procedure for generating layout data;

FIG. 7 shows a layout;

FIG. 8 shows a layout;

FIG. 9 shows a layout; and

FIG. 10 shows the data structure of accessory data.

### DESCRIPTION OF EMBODIMENTS

FIG. 1 shows a configuration of a layout data generating apparatus 1 according to an embodiment of the present invention. The layout data generating apparatus I is an apparatus for generating layout data indicating the layout of a printed media. The layout data generating apparatus 1 generates layout data using a layout template, which will be described later.

The layout data generating apparatus 1 is configured as a general computer system in which a CPU 11 that performs various types of arithmetic processing, a ROM 12 that stores basic programs, and a RAM 13 that stores various types of information are connected to a bus line. A fixed disk 15 that stores information, a display 16 that displays various types of information, an input receiving part 17 including a keyboard 17a and a mouse 17b that accept input from an operator, a reading/writing device 18 that reads/writes information from/to a computer-readable storage medium 10 such as an optical disk, a magnetic disk, or a magneto-optical disk, and a communication part 19 that performs communication with external devices are further appropriately connected to the bus line via an interface (I/F), for example.

In the layout data generating apparatus 1, a program 100 that has been read out in advance from the storage medium 10 through the reading/writing device 18 is stored in the fixed disk 15. The program 100 may be loaded into the layout data generating apparatus 1 through the communication part 19. The layout data generating apparatus 1 generates layout data by the CPU 11 executing the program 100 in the RAM 13 or the like (i.e., by the computer executing the program).

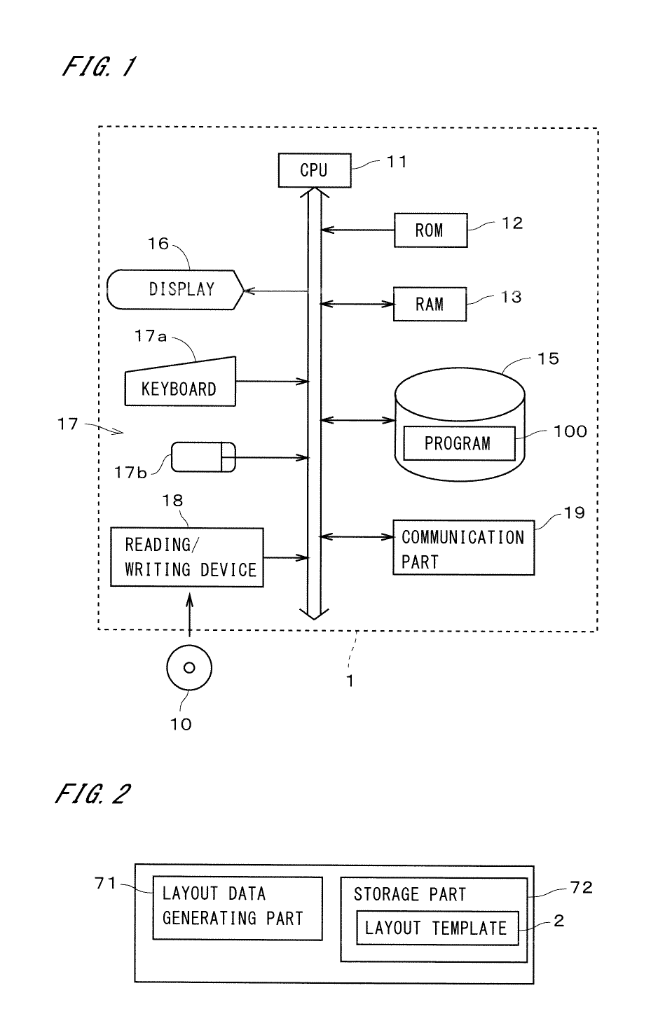

FIG. 2 is a block diagram showing a functional configuration realized by, for example, the CPU 11, the ROM 12, the RAM 13, and the fixed disk 15, as a result of the CPU 11 operating in accordance with the program 100. In FIG. 2, a layout data generating part 71 is a function realized by the CPU 11 or the like, and a storage part 72 is a function realized by the fixed disk 15 or the like. Note that these functions may be realized by a dedicated electrical circuit, or an electric circuit may be used for parts of these functions. A layout template 2 with a data structure to be used for generating layout data is stored in the storage part 72.

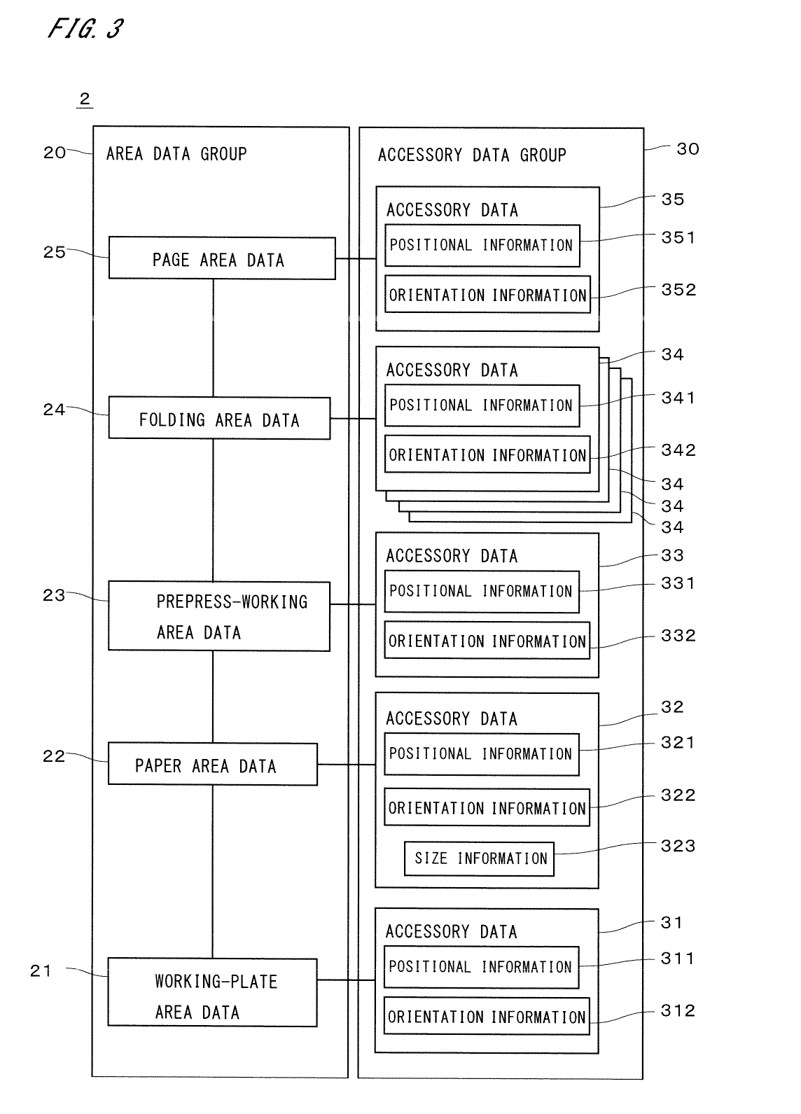

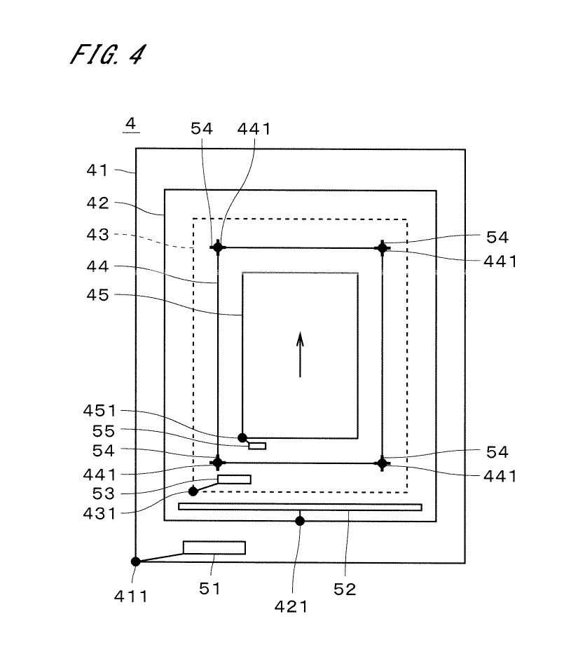

FIG. 3 shows the data structure of the layout template 2, and FIG. 4 shows a layout model 4 corresponding to the layout template 2. The layout template 2 is to be used for working-plate printing. As shown in FIG. 3, the layout template 2 includes an area data group 20 and an accessory data group 30. The area data group 20 includes working-plate area data 21, paper area data 22, prepress-working area data 23, folding area data 24, and page area data 25.

The working-plate area data 21 corresponds to a working-plate area 41 of the layout model 4 shown in FIG. 4, and the paper area data 22 corresponds to a paper area 42 to be arranged on the working-plate area 41. A single paper area 42 is to be arranged on a single working-plate area 41. The prepress-working area data 23 corresponds to a prepress-working area 43 to be arranged on the paper area 42. A single prepress-working area 43 is to be arranged on a single paper area 42.

The folding area data 24 corresponds to a folding area 44 to be arranged on the prepress-working area 43. A single or a plurality of folding areas 44 are to be arranged on a single prepress-working area 43. In the layout model 4 shown in FIG. 4, a single folding area 44 is to be arranged on a single prepress-working area 43. The page area data 25 corresponds to a page area 45 to be arranged on the folding area 44. A single or a plurality of page areas 45 are to be arranged on a single folding area 44. In the layout model 4 shown in FIG. 4, a single page area 45 is to be arranged on a single folding area 44.

The page area data 25 includes size information indicating the vertical and horizontal lengths of the page area 45, variables. The page area data 25 also includes information indicating the orientation of an image to be printed on the page area 45. In FIG. 4, the orientation of the image is indicated by the arrow in the center of the page area 45. In order to simplify the figure, the size information included in the page area data 25 has been omitted from FIG. 3. Likewise, later-described size information and the like included in the folding area data 24, the prepress-working area data 23, the paper area data 22, and the working-plate area data 21 have also been omitted.

The folding area data 24 includes size information regarding the folding area 44, the number of page areas 45 to be arranged on the folding area 44, and the position (s) of the page area (s) 45 on the folding area 44, as variables. The prepress-working area data 23 includes size information regarding the prepress-working area 43, the number of folding areas 44 to be arranged on the prepress-working area 43, and the position (s) of the folding area (s) 44 on the prepress-working area 43, as variables. The paper area data 22 includes size information regarding the paper area 42 and the position of the prepress-working area 43 on the paper area 42, as variables. The working-plate area data 21 includes size information regarding the working-plate area 41 and the position of the paper area 42 on the working-plate area 41, as variables.

The accessory data group 30 includes a plurality of accessory data pieces 31 to 35 corresponding respectively to a plurality of accessories 51 to 55. The accessories 51 to 55 serve as additional print information to be used in a printing process or a binding process, examples of which include a register mark, a color bar, a color patch, a signboard, and a mark for gutter alignment.

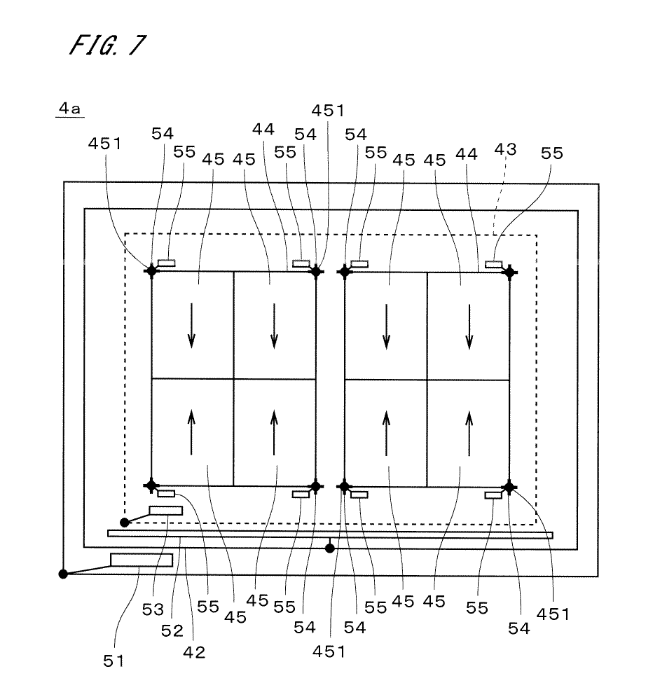

The accessory 51 is associated with the working-plate area 41, and the accessory data 31 is associated with the working-plate area data 21. As shown in FIG. 5, nine reference points 411 are set in the working-plate area 41. The reference points 411 are set at the center, the four vertices, and the middles of the four sides of the rectangular working-plate area 41. The accessory data 31 includes positional information 311 indicating the relative position of the accessory 51 with respect to one of the nine reference points 411 in the working-plate area 41. In the example of FIG. 4, the positional information 311 indicates that, with use of the lower left reference point 411 in the working-plate area 41 as a reference, the accessory 51 is arranged at a predetermined position in the upper right of that reference point 411. Note that the straight line connecting the accessory 51 and the reference point 411 merely indicates the reference point 411 with which the accessory 51 is associated, and is actually not shown (the same applies to the other accessories and FIGS. 7 to 9).

The accessory data 31 also includes orientation information 312 indicating the orientation of the accessory 51 relative to the orientation of the working-plate area 41. The orientation information 312 is generally one of the following: a reference orientation that is an orientation used as a reference, the orientation rotated by 90 from the reference orientation, the orientation rotated by 180 from the reference orientation, and the orientation rotated by 270 from the reference orientation. Note that if an accessory has, for example, a circular shape with a single color and is not affected by the orientation, the orientation information regarding that accessory does not need to be included in the accessory data.

The accessory 52 is associated with the paper area 42, and the accessory data 32 is associated with the paper area data 22. The accessory data 32 includes positional information 321 indicating the relative position of the accessory 52 with respect to a reference point in the paper area 42, and orientation information 322 indicating the orientation of the accessory 52 relative to the orientation of the paper area 42. In the example of FIG. 4, the positional information 321 indicates that, with use of the lower middle reference point 421 in the paper area 42 as a reference, the accessory 52 is arranged at a predetermined position above that reference point 421. Note that size information 323 included in the accessory data 32 will be discussed later.

The accessory 53 is associated with the prepress-working area 43, and the accessory data 33 is associated with the prepress-working area data 23. The accessory data 33 includes positional information 331 indicating the relative position of the accessory 53 with respect to a reference point in the prepress-working area 43, and orientation information 332 indicating the orientation of the accessory 53 relative to the orientation of the prepress-working area 43. In the example of FIG. 4, the positional information 331 indicates that, with use of the lower left reference point 431 in the prepress-working area 43 as a reference, the accessory 53 is arranged at a predetermined position in the upper right of that reference point 431.

The accessories 54 are associated with the folding area 44, and the accessory data pieces 34 are associated with the folding area data 24. The accessory data pieces 34 each include positional information 341 indicating the relative position of the accessory 54 with respect to a reference point in the folding area 44, and orientation information 342 indicating the orientation of the accessory 54 relative to the orientation of the folding area 44. In the example of FIG. 4, the four accessories 54 (cross-shaped register marks) are associated with the folding area 44. The positional information pieces 341 of the four accessory data pieces 34 indicate that the accessories 54 are arranged on reference points 441 that are set at the four vertices of the folding area 44.

The accessory 55 is associated with the page area 45, and the accessory data 35 is associated with the page area data 25. The accessory data 35 includes positional information 351 indicating the relative position of the accessory 55 with respect to a reference point in the page area 45, and orientation information 352 indicating the orientation of the accessory 55 relative to the orientation of the page area 45. In the example of FIG. 4, the positional information 351 indicates that, with use of the lower left reference point 451 in the page area 45 as a reference, the accessory 55 is arranged at a predetermined position in the lower right of that reference point 451 (a position on the folding area 44). In the case where page areas 45 are arranged adjacent to each other the left-right direction, for even-numbered page areas 45 counting from the left when viewed so that images to be printed on the page areas 45 are upwardly oriented (i.e., the arrow in FIG. 4 points upward), the positional information 351 indicates that, with use of the lower right reference point 451 in the page area 45 as a reference, the accessory 55 is arranged at a predetermined position in the lower left of that reference point 451.

In the following description, an area with which an accessory is associated is referred to as a reference area of that accessory. For example, a reference area with which the accessory 51 is associated is the working-plate area 41, and a reference area with which the accessory 52 is associated is the paper area 42. As described above, although in the layout model 4 shown in FIG. 4, a single accessory is associated with each of the working-plate area 41, the paper area 42, the prepress-working area 43, and the page area 45 and the four accessories 54 are associated with the folding area 44, the number of accessories to be associated with each area or the presence or absence of an accessory to be associated with each area can be appropriately changed.

In the case where the size of an accessory needs to be changed due to a change in the size of the reference area, the accessory data further includes size information regarding the accessory as a function of size information regarding the reference area, in addition to the positional information and the orientation information regarding the accessory. In the example of FIG. 4, the accessory 52 associated with the paper area 42 is a color bar having a width 0.9 times that of the paper area 42 in the left-right direction in the figure, and the accessory data 32 shown in FIG. 3 includes, as the size information 323 regarding the accessory 52, a function that defines the width of the accessory 52 as 0.9 times that of the paper area 42 (which is included in the size information regarding the paper area 42).

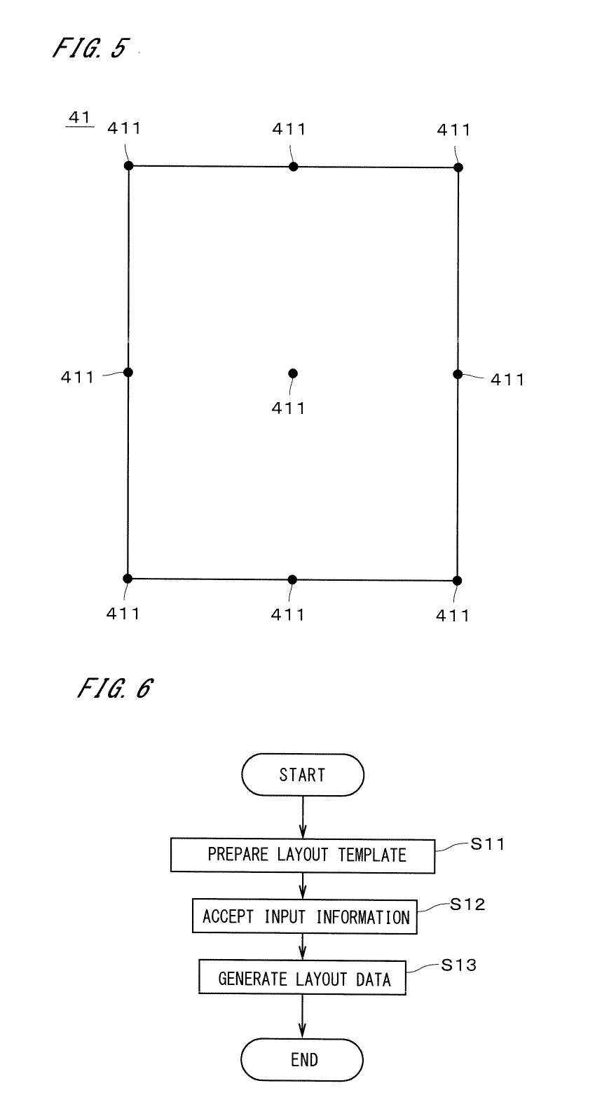

Next, the procedure for layout data generation performed by the layout data generating apparatus 1 will be described with reference to FIG. 6. With the layout data generating apparatus 1, first the layout template 2 corresponding to the layout model 4 shown in FIG. 4 is stored in the storage part 72 as a preparation (step S11). Next, the input receiving part 17 (see FIG. 1) accepts input information (input values) indicating actual values for the information included as variables in the page area data 25, the folding area data 24, the prepress-working area data 23, the paper area data 22, and the working-plate area data 21 (step S12).

In the present embodiment, the above input information includes actual values for the size information regarding the page area 45, the size information regarding the folding area 44, the number of page areas 45 to be arranged on the folding area 44, the position (s) of the page area (s) 45 on the folding area 44, the size information regarding the prepress-working area 43, the number of folding areas 44 to be arranged on the prepress-working area 43, the position (s) of the folding area (s) 44 on the prepress-working area 43, the size information regarding the paper area 42, the position of the prepress-working area 43 on the paper area 42, the size information regarding the working-plate area 41, and the position of the paper area 42 on the working-plate area 41.

Then, layout data is generated by the layout data generating part 71 (see FIG. 2) substituting that input information into the variables in the page area data 25, the folding area data 24, the prepress-working area data 23, the paper area data 22, and the working-plate area data 21 of the layout template 2 (step S13).

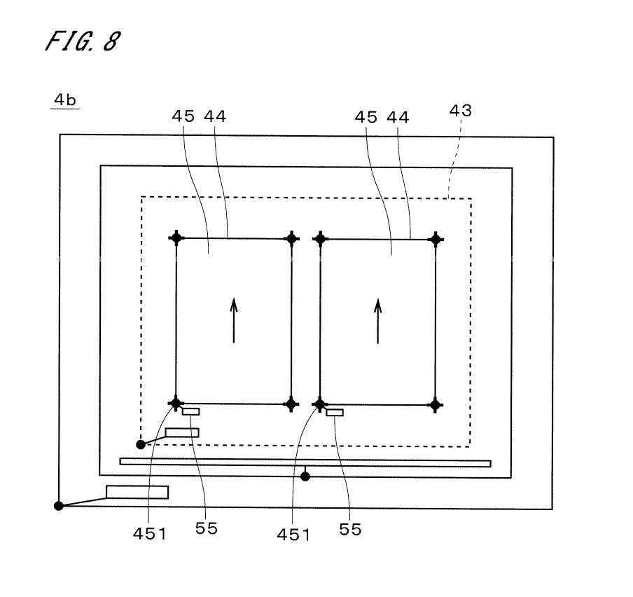

FIGS. 7 to 9 show layouts 4a to 4c, respectively, each corresponding to the layout data generated by substitution of different input information into the variables of the layout template 2. The input information regarding the layout 4a in FIG. 7 includes a value of “2” indicating the number of folding areas 44 to be arranged on the prepress-working area 43 and positional information pieces indicating the positions of the respective two folding areas 44 on the prepress-working area 43. This input information also includes a value of “4” indicating the number of page areas 45 to be arranged on each of the folding areas 44, and positional information pieces indicating the positions of the respective four page areas 45 on the folding area 44. In the layout 4a, the edge of each of the folding areas 44 and the outer edges of the four page areas 45 on the folding area 44 overlap. The positional information regarding the page areas 45 also includes information indicating the orientations of images to be printed on the page areas 45. In FIG. 7, the orientations of the images are indicated by the arrows in the centers of the page areas 45 (the same applies to FIGS. 8 and 9).

In the layout 4a, the accessories 51 to 55 are respectively arranged at predetermined positions in accordance with the accessory data pieces 31 to 35. As described above, the width of the accessory 52 associated with the paper area 42 is 0.9 times that of the paper area 42 in the left-right direction. Furthermore, as for the accessories 55 associated with the page areas 45, those associated with odd-numbered page areas 45 counting from the left when viewed so that images to be printed on the page areas 45 are upwardly oriented (i.e., the arrows in FIG. 7 point upward) are each arranged at a predetermined position in the lower right of the lower left reference point 451 in the corresponding page area 45, whereas those associated with even-numbered page areas 45 are each arranged at a predetermined position in the lower left of the lower right reference point 451 in the corresponding page area 45.

The input information regarding the layout 4b in FIG. 8 includes a value of “2” indicating the number of folding areas 44 to be arranged on the prepress-working area 43 and positional information pieces indicating the positions of the respective two folding areas 44 on the prepress-working area 43. This input information also includes a value of “1” indicating the number of page areas 45 to be arranged on each of the folding areas 44. In the layout 4b, the edge of each of the folding areas 44 and the edge of the page area 45 on the folding area 44 overlap. In the layout 4b, since the two page areas 45 are spaced from each other, the two accessories 55 are each arranged at a predetermined position in the lower right of the lower left reference point 451 in the corresponding page area 45.

The input information regarding the layout 4c in FIG. 9 includes a value of “1” indicating the number of folding areas 44 to be arranged on the prepress-working area 43 and positional information indicating the position of the folding area 44 on the prepress-working area 43. This input information also includes a value of “8” indicating the number of page areas 45 to be arranged on the folding area 44 and positional information pieces indicating the positions of the respective eight page areas 45 on the folding area 44. In the layout 4c, the edge of the folding area 44 and the outer edges of the eight page areas 45 on the folding area 44 overlap.

As described above, in the area data group 20 of the layout template 2, information pieces regarding the working-plate area 41, the paper area 42, the prepress-working area 43, the folding area (s) 44, and the page area (s) 45 are defined as variables. In the accessory data group 30, the accessories 51 to 55 are associated with their respective reference areas, and their positions are defined as relative positions with respect to the reference points 411 to 451 set in the reference areas. This enables the layout data generating apparatus 1 to readily respond to a change in printing conditions (e.g., a change in the s f the page area (s) 45, the paper area 42 or the like) and quickly generate layout data. As a result, it is possible to improve productivity of a printing operation. Furthermore, storing the layout template, instead of layout data that varies for each printing condition, eliminates the need to manage a large number of layout data pieces and makes it possible to reduce the effort required for management of data regarding printing.

In the layout template 2, in the case where the size of an accessory needs to be changed due to a change in the size of the reference area, the accessory data includes size information regarding the accessory as a function of size information regarding the reference area. Accordingly, a single layout template 2 can respond to a variable accessory size. As a result, it is possible to further reduce the effort required for management of data regarding printing.

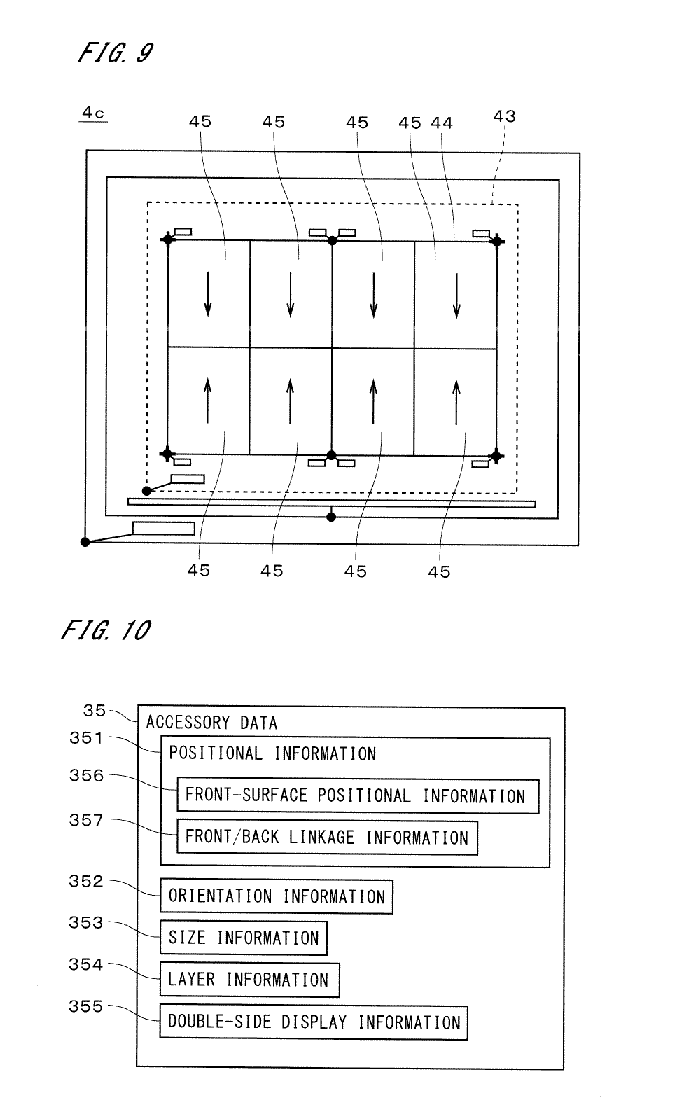

Although in FIG. 3, only the accessory data 32 associated with the paper area data 22 includes the size information 323, each accessory data piece in the layout template 2 may include size information. Furthermore, each accessory data piece may include various types of information other than the positional information, the orientation information, and the size information regarding the accessory. FIG. 10 shows an example of the data structure of the accessory data 35 associated with the page area data 25. The accessory data 35 shown in FIG. 10 includes layer information 354 and double-side display information 355, in addition to the positional information 351, the orientation information 352, and the size information 353. The positional information 351 includes front-surface positional information 356 and front/back linkage information 357.

The layer information 354 is information indicating an above/below relationship between a layer of the accessory 55 and a layer of an image in the page area 45 (i.e., the reference area), and is included as a variable in the accessory data 35. For example, if the accessory 55 is arranged within in the page area 45, in the case of displaying the accessory 55, a value indicating that the accessory 55 is to be displayed after display of an image in the page area 45 (i.e., the accessory is defined as an image above the reference area) is input and substituted into the layer information 354 of the accessory data 35. In the case where the accessory 55 is to be hidden, a value indicating that the accessory 55 is to be displayed before display of an image in the page area 45 (i.e., the accessory is defined as an image below the reference area) is input and substituted into the layer information 354 of the accessory data 35. This makes it easy to set whether or not to display the accessory 55.

The double-side display information 355 is information indicating, in the case of performing double-side printing on a printing medium, whether the accessory 55 is printed on the front surface of the printing medium or the back surface thereof, and it is included as a variable in the accessory data 35. In this case, the input information includes one of a value indicating that the accessory 55 is to be printed on only the front surface, a value indicating that the accessory 55 is to be printed on only the back surface, and a value indicating that the accessory 55 is to be printed on both sides, and this value is input in the double-side display information 355 of the accessory data 35. By including the double-side display information 355 in the accessory data 35, a single layout template 2 can respond to the case of double-side printing.

The front-surface positional information 356 is positional information regarding an accessory 55 to be printed on the front surface of a printing medium (such an accessory is hereinafter referred to as a “front-surface accessory 55”). The front/back linkage information 357 is information for determining the position of an accessory 55 to be printed on the back surface of the printing medium (such an accessory is hereinafter referred to as a “back-surface accessory 55”), based on the front-surface positional information 356. By including the front-surface positional information 356 and the front/back linkage information 357 in the positional information 351 of the accessory data 35, a single layout template 2 can respond to even the case where the position of the front-surface accessory 55 is different from the position of the back-surface accessory 55.

In the case where the layout template is used to generate layout data for non-plate printing such as inkjet printing or digital printing, the working-plate area data 21 and the accessory data 31 regarding the accessory 51 associated with the working-plate area 41 are omitted from the layout template 2. In the layout template used in non-plate printing, the accessory 52 associated with the paper area 42 is, for example, a flashing ejection pattern formed by flashing in which ink is ejected from all outlets in order to maintain a favorable ink ejection state.

While the above has been a description of an embodiment of the present invention, the present invention is not intended to be limited to the above-described embodiment, and various modifications are possible.

For example, in the positional information regarding an accessory, which is included in accessory data, the distance from a reference point in a reference area to the accessory may be defined as the actual distance or may be defined as a proportion with respect to, for example, the width of the accessory or the reference area. Furthermore, the number and positions of reference points set in a reference area may be appropriately changed, and an accessory may be arranged using any reference point in a reference area as a reference.

In accessory data, the positional information regarding an accessory may indicate the relative position of the accessory with respect to a reference point set in an area that corresponds to other area data included in the area data group 20, instead of a reference point set in the reference area. For example, although an accessory indicating the first page or the last page is associated with the page area, the accessory may be arranged using, as a reference, a reference point set in a working plate in which the first page or the last page is included. Even in this case, it is possible for the layout data generating apparatus 1 to readily respond to a change in printing conditions and to quickly generate layout data as described above. Furthermore, the effort required for the management of data regarding printing can be reduced as well.

The area data group 20 does not necessarily have to include the folding area data 24, the prepress-working area data 23, and the working-plate area data 21 as long as it includes the page area data 25 and the paper area data 22. Note that, in the layout model 4 corresponding to the layout template 2, at least one accessory is associated with a reference area that is either the page area 45 or the paper area 42.

In the case where the folding area data 24 and the prepress-working area data 23 are not included in the area data group 20, the paper area data 22 includes the number of page areas 45 to be arranged on the paper area 42 and the position (s) of the page area (s) 45 on the paper area 42 as variables, instead of the position of the prepress-working area 43 on the paper area 42. Note that even in the case where the folding area data 24 and the prepress-working area data 23 are included in the area data group 20, the paper area data 22 includes the number of page areas 45 to be arranged on the paper area 42 and the position (s) of the page area (s) 45 on the paper area 42 as some of variables through the prepress-working area data 23 and the folding area data 24.

The configurations of the above-described embodiment and the modifications may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention. This application claims priority benefit under 35 U.S.C. Section 119 of Japanese Patent Application No. 2011-75665 filed in the Japan Patent Office on Mar. 30, 2011, the entire disclosure of which is incorporated herein by reference.

1. A layout template to be used for generating layout data indicating a layout of a printed media, comprising:
an area data group including at least one page area data piece that corresponds to a page area, and paper area data that corresponds to a paper area on which said page area is to be arranged; and
at least one accessory data piece that corresponds to an accessory serving as additional print information to be used in a printing process or a binding process,
wherein said at least one page area data piece includes size information regarding said page area as a variable,
said paper area data includes size information regarding said paper area, the number of at least one page area to be arranged on said paper area, and a position of said at least one page area on said paper area as variables,
said accessory is associated with a reference area that is either said page area or said paper area, and
said at least one accessory data piece includes positional information indicating a relative position of said accessory with respect to either a reference point set in said reference area or a reference point set in an area that corresponds to other area data included in said area data group.

2. The layout template according to claim 1, wherein
said at least one accessory data piece further includes size information regarding said accessory as a function of size information regarding said reference area.

3. The layout template according to claim 2, wherein
said at least one accessory data piece further includes layer information indicating an above/below relationship between a layer of said accessory and a layer of an image in said reference area.

4. The layout template according to claim 3, wherein
said at least one accessory data piece further includes double-side display information indicating, in a case where double-side printing is performed on a printing medium, whether said accessory is to be printed on a front surface of said printing medium or to be printed on a back surface of said printing medium.

5. The layout template according to claim 4, wherein
said area data group further includes working-plate area data that corresponds to a working-plate area, said working-plate area data including size information regarding said working-plate area and a position of said at least one paper area on said working-plate area as variables.

6. The layout template according to claim 2, wherein
said at least one accessory data piece further includes double-side display information indicating, in a case where double-side printing is performed on a printing medium, whether said accessory is to be printed on a front surface of said printing medium or to be printed on a back surface of said printing medium.

7. The layout template according to claim 6, wherein
said area data group further includes working-plate area data that corresponds to a working-plate area, said working-plate area data including size information regarding said working-plate area and a position of said at least one paper area on said working-plate area as variables.

8. The layout template according to claim 2, wherein
said positional information regarding said accessory, which is included in said at least one accessory data piece, includes front-surface positional information that is positional information regarding a front-surface accessory to be printed on a front surface of a printing medium, and front/back linkage information for determining a position of a back-surface accessory to be printed on a back surface of said printing medium, based on said front-surface positional information.

9. The layout template according to claim 8, wherein
said area data group further includes working-plate area data that corresponds to a working-plate area, said working-plate area data including size information regarding said working-plate area and a position of said at least one paper area on said working-plate area as variables.

10. The layout template according to claim 1, wherein
said at least one accessory data piece further includes layer information indicating an above/below relationship between a layer of said accessory and a layer of an image in said reference area.

11. The layout template according to claim 10, wherein
said at least one accessory data piece further includes double-side display information indicating, in a case where double-side printing is performed on a printing medium, whether said accessory is to be printed on a front surface of said printing medium or to be printed on a back surface of said printing medium.

12. The layout template according to claim 11, wherein
said area data group further includes working-plate area data that corresponds to a working-plate area, said working-plate area data including size information regarding said working-plate area and a position of said at least one paper area on said working-plate area as variables.

13. The layout template according to claim 1, wherein
said at least one accessory data piece further includes double-side display information indicating, in a case where double-side printing is performed on a printing medium, whether said accessory is to be printed on a front surface of said printing medium or to be printed on a back surface of said printing medium.

14. The layout template according to claim 1, wherein
said positional information regarding said accessory, which is included in said at least one accessory data piece, includes front-surface positional information that is positional information regarding a front-surface accessory to be printed on a front surface of a printing medium, and front/back linkage information for determining a position of a back-surface accessory to be printed on a back surface of said printing medium, based on said front-surface positional information.

15. The layout template according to claim 1, wherein
said area data group further includes working-plate area data that corresponds to a working-plate area, said working-plate area data including size information regarding said working-plate area and a position of said at least one paper area on said working-plate area as variables.

16. The layout template according to claim 1, wherein
said accessory is a flashing ejection pattern to be associated with said paper area.

17. A layout data generating apparatus for generating layout data indicating a layout of a printed media, comprising:
a storage part that stores a layout template including an area data group and at least one accessory data piece, said area data group including at least one page area data piece that corresponds to a page area and paper area data that corresponds to a paper area on which said page area is to be arranged, and said at least one accessory data piece that corresponds to an accessory serving as additional print information to be used in a printing process or a binding process;
an input receiving part that accepts input information including size information regarding said page area, size information regarding said paper area, the number of at least one page area to be arranged on said paper area, and a position of said at least one page area on said paper area; and
a layout-data generating part that generates layout data by substituting said input information into said layout template,
wherein said at least one page area data piece includes size information regarding said page area as a variable,
said paper area data includes size information regarding said paper area, the number of said at least one page area to be arranged on said paper area, and a position of said at least one page area on said paper area as variables,
said accessory is associated with a reference area that is either said page area or said paper area, and
said at least one accessory data piece includes positional information indicating a relative position of said accessory with respect to either a reference point set in said reference area or a reference point set in an area that corresponds to other area data included in said area data group.

18. A layout data generating method to be used in a layout data generating apparatus, for generating layout data indicating a layout of a printed media, said layout data generating apparatus including an input receiving part and a layout data generating part, the method comprising the steps of:
a) preparing a layout template including an area data group and at least one accessory data piece, said area data group including at least one page area data piece that corresponds to a page area and paper area data that corresponds to a paper area on which said page area is to be arranged, and said at least one accessory data piece that corresponds to an accessory serving as additional print information to be used in a printing process or a binding process; and
b) generating layout data by said input receiving part accepting input information and said layout data generating part substituting said input information into said layout template, said input information including size information regarding said page area, size information regarding said paper area, the number of at least one page area to be arranged on said paper area, and a position of said at least one page area on said paper area,
wherein said at least one page area data piece includes size information regarding said page area as a variable,
said paper area data includes size information regarding said paper area, the number of said at least one page area to be arranged on said paper area, and a position of said at least one page area on said paper area as variables,
said accessory is associated with a reference area that is either said page area or said paper area, and
said at least one accessory data piece includes positional information indicating a relative position of said accessory with respect to either a reference point set in said reference area or a reference point set in an area that corresponds to other area data included in said area data group.

19. A storage medium storing a program for generating layout data indicating a layout of a printed media, said program being executable by a computer comprising a CPU, a memory, and an input receiving part, and said program causing, as a result of said CPU executing said program in said memory, said computer to execute the steps of:
a) preparing a layout template including an area data group and at least one accessory data piece, said area data group including at least one page area data piece that corresponds to a page area and paper area data that corresponds to a paper area on which said page area is to be arranged, and said at least one accessory data piece that corresponds to an accessory serving as additional print information to be used in a printing process or a binding process; and
b) generating layout data by said input receiving part accepting input information and said layout data generating part substituting said input information into said layout template. said input information including size information regarding said page area, size information regarding said paper area, the number of at least one page area to be arranged on said paper area, and a position of said at least one page area on said paper area,
wherein said at least one page area data piece includes size information regarding said page area as a variable,
said paper area data includes size information regarding said paper area, the number of said at least one page area to be arranged on said paper area, and a position of said at least one page area on said paper area as variables,
said accessory is associated with a reference area that is either said page area or said paper area, and
said at least one accessory data piece includes positional information indicating a relative position of said accessory with respect to either a reference point set in said reference area or a reference point set in an area that corresponds to other area data included in said area data group.
